(19) United States
(12) Patent Application Publication
(10) Pub. No.: US 2026/0227755 A1
(43) Pub. Date: Aug. 6, 2026

(54) FLEXIBLE IN-FIELD RE-MARKING FOR MICROCONTROLLERS

(71) Applicant: Infineon Technologies AG, Neubiberg (DE)

(72) Inventors: Thomas Röcker, München (DE); Moritz Höchner, Nassach (DE); Jörg Seitter, Esslingen (DE); Albrecht Mayer, Waakirchen (DE)

(21) Appl. No.: 19/043,553

(22) Filed: Feb. 3, 2025

(51) Int. Cl. G05B 19/05

(52) U.S. Cl. CPC G05B 19/056

(57) ABSTRACT

Systems, methods, and circuitries are provided for enabling in-field re-marking of micro controllers. In one example, a micro-controller unit (MCU), includes one or more processors; non-reprogrammable memory, reprogrammable memory, and marking circuitry. The non-reprogrammable memory is configured to store an umbrella license file defining a first set of MCU functions or MCU resources that are enabled for execution or access by the one or more processors and a second set of MCU functions or MCU resources that are permanently disabled for execution or access by the one or more processors. The reprogrammable memory is configured to store an actual license file defining a third set of MCU functions or MCU resources that are licensed for execution or access by the one or more processors. The marking circuitry configured to control access to the MCU functions and MCU resources based on the umbrella license file and the actual license file.

### FIELD

The present disclosure relates generally to the field of processors and micro controller units (MCUs) and more particularly to techniques that support in-field re-marking, or modification of features provided by an MCU after MCU deployment.

### BACKGROUND

A technique referred to as marking or wounding may be used to disable certain hardware/features of an MCU to provide different MCU variants without having to produce dedicated silicon variants. In marking, certain features such as a number of cores, an amount of memory, peripheral configurations, and so on may be disabled or blocked from access by actions taken by software during the boot-phase of the MCU.

### BRIEF DESCRIPTION OF THE DRAWINGS

Some examples of circuits, apparatuses and/or methods will be described in the following by way of example only. In this context, reference will be made to the accompanying Figures.

FIG. 1 is a block diagram illustrating an example micro-controller unit (MCU), in accordance with various aspects described.

FIG. 2 is a block diagram of an example marking circuitry, in accordance with various aspects described.

FIG. 3 is a block diagram of an example update circuitry, in accordance with various aspects described.

### DETAILED DESCRIPTION

The present disclosure is described with reference to the attached figures. Similar components in various figures may be represented by similar reference characters. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

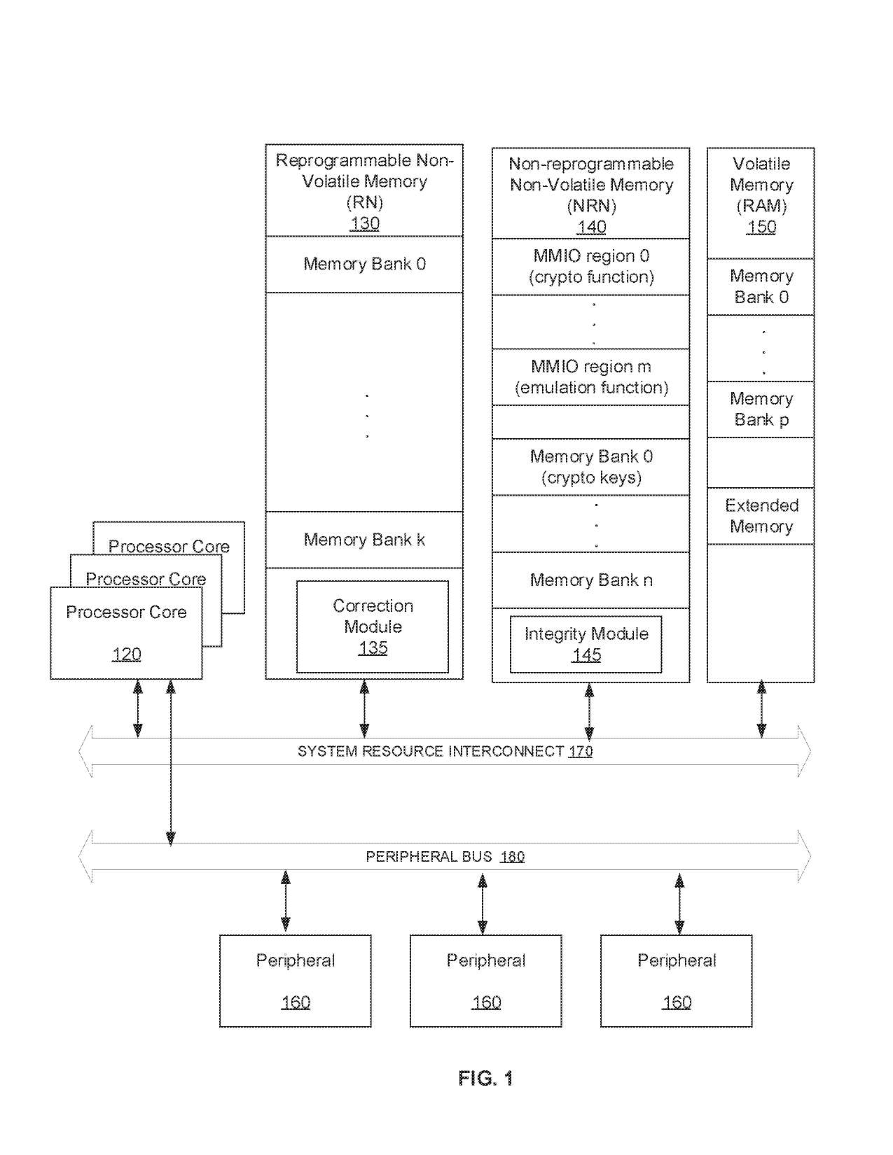

FIG. 1 illustrates an example micro-controller unit (MCU) which may be implemented as a system-on-chip (SoC). The MCU includes one or more processor cores 120, reprogrammable non-volatile memory (RN) 130, non-reprogrammable non-volatile memory (NRN) 140, volatile memory (RAM) 150 connected to one another by a system resource interconnect 170. The MCU also includes a plurality of peripherals 160 that are accessible to the processor cores 120 by way of a peripheral bus 180.

The MCU provides system functions, sometimes called master functions, which comprise one or more processor cores 120 (or virtual machines instantiated on the processor cores) reading, manipulating, and writing data to the RN 130 and/or access services provided by the peripherals 160. Each master function may be allocated separate, possibly non-overlapping, physical resources such as processor cores 120 or virtual machines instantiated on the processor cores, portions of RN 130 or NRN 140, or peripherals 160.

Each processor core 120 may include dedicated portions of RAM 150 for use as program or data caches or buffers. The RN 130, the NRN 140, and the RAM 150 include memory banks which correspond to a range or set of memory locations that may be separately allocated to a given system function. When a memory bank is allocated to a certain system function, the memory bank is not accessible to other processor cores or system functions. The MCU may employ various mechanisms, such as, for example, memory protection units (MPU), to implement memory allocations. MPUs may be used to limit a range of memory address that may be accessed by a given system function. Other and/or additional mechanisms may be used to allocate memory and prevent access to memory banks by a system function to which the memory bank is not allocated.

The RN 130 may include a correction module 135 that corrects errors in data being read from the RN 130. The correction module 135 may use an error correcting code (ECC) to change bit values of data being read based on a stored ECC value associated with the stored data. Other or additional data correction and/or integrity protection measures may be taken by the correction module 135,

The NRN 140 may be fused-based memory in which physical fuses are opened or left in tact during production of the MCU to store bit values. These fuses may not be opened by any software based measures that might be taken by the MCU and thus may not be changed after production of the MCU or “in-field”. Other types of memory that cannot be modified in-field may be used by the NRN 140. The NRN 140 may include an integrity module 145 that verifies that data being read from the NRN 140 has not been modified or corrupted. For example, the integrity module 145 may implement a technique in which blocks of data are subject to protection by cyclic redundancy codes (CRC) that are computed for each block of data and stored with the data. The CRC code for each block of data is confirmed at read time. Other or additional integrity and/or data correction measures may be taken by the integrity module 145.

The NRN 140 may include memory mapped input/output MMIO regions corresponding to an address-slice of the NRN 140. An MMIO region may include fuse-based memory or other read-only memory (ROM). An MMIO region may store program data that is transferred to certain registers when a function is instantiated to enable hardware or software to execute the function. An MMIO may store program instructions that, when executed by a processor core, provide a certain system function. In some examples, fuse-based NRN is used to store program data while ROM-based NRN is use to store instructions for performing a function. For example, certain MMIO regions may store data and/or instructions that enable execution of a cryptographic function while others MMIO region may store data and/or instructions that enable an emulation function that may be used for debugging the MCU. The emulation instructions may be performed by a dedicated processor core and using an allocated extended memory portion of RAM that is configured to store trace results of the emulation process. Together these elements comprise an emulation device, and enabling these elements allows the MCU to perform various actions used in debugging. For example, the emulator device may allow a developer to simulate different operating conditions for the MCU and trace the behavior of certain portions of software code being developed by saving trace data. The emulation feature may be used during development of the MCU but not by end consumers of the MCU.

An MCU manufacturer may desire to sell different versions of the MCU at different price points and providing different functionality. Further, import/export regulations may require that certain features be permanently disabled, such as cryptographic algorithms that are not allowed to be exported to certain countries. To this end, MCU manufactures may mark or wound the MCU by setting fuse-based memory to prevent access to program data and prevent execution of certain system functions or by locking access to configuration registers associated with different system resources such as memory banks, processor cores, and peripherals to disable certain features. Thus, for each different licensed version of the MCU, a different physical version of the MCU is created. Thus, it is difficult if not impossible to change the set of available features for an MCU after production of the MCU.

Described herein are systems, circuitries, and methods for supporting in-field re-marking of an MCU to allow for changes in feature availability while providing protections against unauthorized re-marking or misuse of licenses.

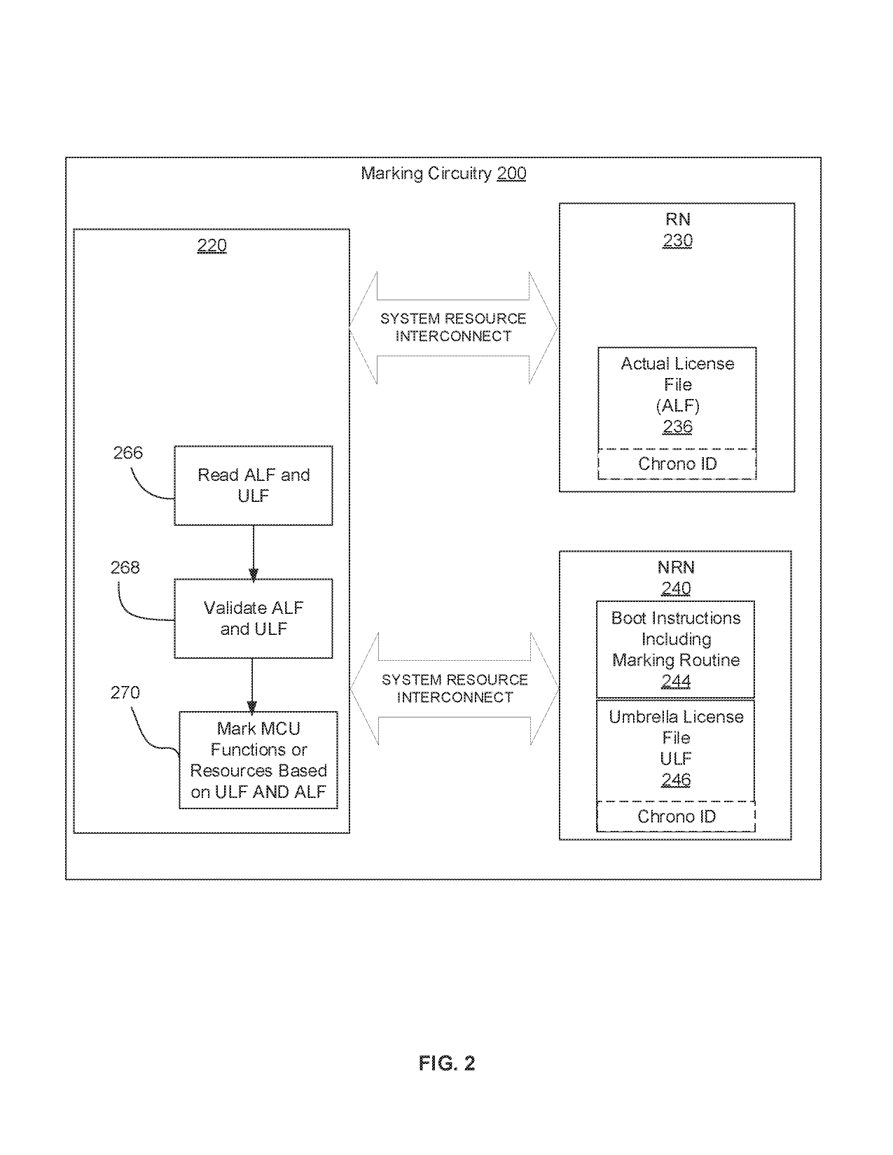

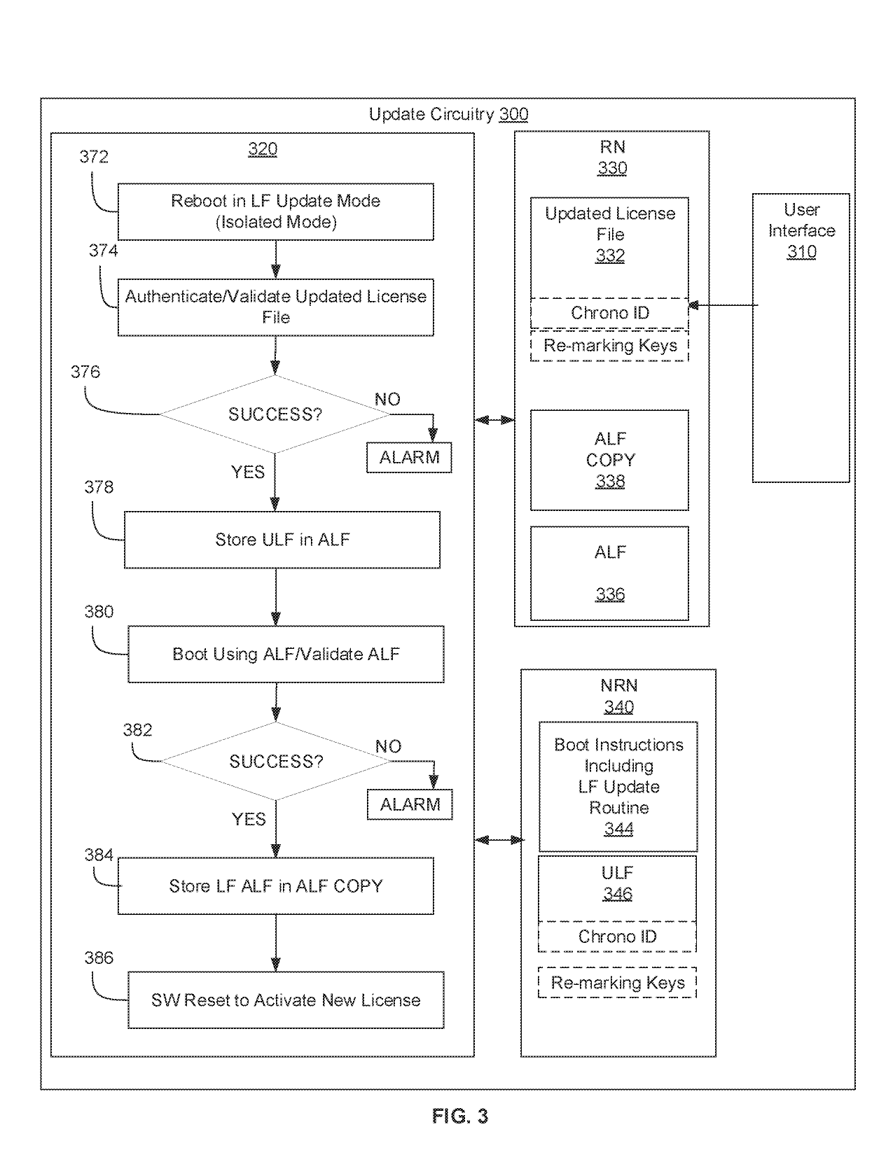

Referring now to FIG. 2, the MCU includes marking circuitry 200 that controls access to MCU functions and/or resources based on an umbrella license file 246 stored in NRN 240 and an actual license file 236 stored in RN 230. The umbrella license file 246 defines a set of permanently disabled MCU functions and/or resources and a set of allowable (not permanently disabled) MCU functions and/or resources. The umbrella license file 246 cannot be modified because it is stored in NRN 240 and is thus subject to the physical protections against modification as well as the integrity assurance measures provided by the NRN 240. The actual license file 236 defines a set of authorized MCU functions and/or resources based on a current license. The actual license file 236 is stored in RN and may be securely updated in-field as will be described herein with reference to FIG. 3.

The marking circuitry 200 controls access to the MCU functions and/or resources is controlled based on both the actual license file 236 and the umbrella license file 246. For example, the marking circuitry 200 may enable MCU functions and/or resources that are authorized by the actual license file and are not permanently disabled by the umbrella license file. In this manner, for each version of the MCU a super set of MCU functions and/or resources may be defined as allowable by the umbrella license file while other MCU functions and/or resources may be permanently disabled in the MCU version.

Thus, each MCU version may have a set of permanently disabled MCU functions and/or resources while the possibility of re-marking the MCU in-field to modify the authorized MCU functions and/or resources to include different sets of allowable (as per the umbrella license file) MCU functions and/or resources is retained. This capability of permanently disabling certain MCU functions and/or resources is beneficial for several reasons. For example, testing and validation of a certain MCU version need not include testing of permanently disabled MCU functions and/or resources. Further, MCU functions and/or resources such as cryptographic services or key storage may be permanently disabled to comply with export control regulations.

The umbrella license file 246 and the actual license file 236, referred to collectively as the license files, may have similar configurations to facilitate determination of properly licensed MCU functions and/or resources by the marking circuitry 200. For example, the license files may contain information indicating which of a number of MCU functions (e.g., cryptographic services, enhanced digital signal processing functions, and so on), memory banks, and an emulation device are authorized/allowed.

For example, the licensing information may be encoded as bit vectors that include a bit position for each MCU function, memory bank, and/or emulation device. The values in the bit positions either allow or disallow the corresponding MCU function, memory bank, and/or emulation device. It is noted that the bit values in the bit vector of the umbrella license file 246 may not be changed (e.g., based on fuses or other physically irreversible memory) while the bit values in the bit vector of the actual license filed may be modified as will be described with reference to FIG. 3. In this manner the marking circuitry 200 may control access to the MCU functions, memory banks, and emulation device based on a logical AND combination of the bit vector in the actual license file 236 and the bit vector in the umbrella license file 246.

In one example, the marking circuitry 200 includes boot firmware including a lockstep processor 220 and boot instructions 244 stored in NRN 240. When a software reset or power-up of the MCU occurs, the first operation is performance of the boot instructions by the lockstep processor core. The lockstep processor core includes two processors that execute the boot instructions in parallel and compare the results of each instruction. When the results do not match, an alarm is generated and additional remedial actions may be taken. This is in compliance with safety standards that may apply in automotive applications. In other examples, other or additional safety measures may be taken to enhance the safety of the execution of the boot instructions.

The boot instructions include a marking routine that is outlined by the flow diagram illustrated within the lockstep processor 220. At 266, the actual license file 236 and the umbrella license file 246 are read by the lockstep processor 220. At 268 the actual license file and the umbrella license file may be validated.

For example, signatures contained in the actual license file and/or the umbrella license file may be validated to confirm their legitimacy. Further, a chronological identifier string encoding a serial number, a version number, and/or a version date contained in the actual license file 236 may be compared to a chronological identifier string encoding a serial number, a version number, and/or a version date contained in the umbrella license file. The license files may only be validated if the serial number, a version number, and/or a version date in the actual license file is later than the serial number, a version number, and/or a version date in the umbrella license file. In this manner, a older license may not be used to upscale later purchased MCU versions with limited MCU functions and/or resources.

At 270, MCU functions and/or resources are marked by the lockstep processor 220 to disable them based on the actual license file and the umbrella license file. As discussed above, this may be accomplished by enabling memory protection measures to prevent access to memory ranges (e.g., MMIO regions) that store program data or instructions for performing certain functions, locking access to registers that are required to perform certain functions or enable access to certain cores, memories, or peripheral devices, and so on.

It is noted that the MCU may function in an unlocked mode during development. In the unlocked mode, the marking circuitry 200 controls access to MCU functions and/or resources based solely on the umbrella license file 246 without consideration of the actual license file 236. In this manner the super set of allowable features may be tested. Once testing is complete, the actual license file for the particular version may be programmed and the MCU may be locked, for example, by setting a fuse or other physically irreversible measure.

FIG. 3 is a block diagram of an example update circuitry 300 that authenticates and validates an updated license file received through a user interface to support in-field re-marking of an MCU. The RN 330 includes memory configured to store an updated license file 332, an actual license file 336, and a copy of an actual license file 338. The actual license file 336 is the license filed used by marking circuitry to mark the MCU upon boot. The NRN 340 includes memory configured to store boot instructions for update mode 344, which include a license file update routine. The NRN 340 may also include memory for storing re-marking keys, such as a password or signature that may be used to authenticate an updated license file.

Operations performed by a lockstep processor 320 are outlined in the flowchart. At 372, when an updated license file 332 is written to RN 330 by a user interface 310, the update circuitry triggers a reboot in update mode, which is an isolated mode in which no debug access or external communication is allowed and load-jumps are limited. At 374, the updated license file is authenticated and/or validated. The authentication may be performed by comparing a re-marking key provided with the updated license file (either as a string within the file or as a separate input) to the re-marking keys stored in the NRN 340.

To validate the updated license file, a chronological identifier string encoding a serial number, a version number, and/or a version date contained in the actual license file 336 may be compared to a chronological identifier string encoding a serial number, a version number, and/or a version date contained in the umbrella license file 346. The license files may only be validated if the serial number, a version number, and/or a version date in the actual license file is later than the serial number, a version number, and/or a version date in the umbrella license file. In this manner, a older license may not be used to upscale later purchased MCU versions that provide limited MCU functions and/or resources.

If the authentication and/or validation is not successful, at 376 an alarm is triggered indicating that an unsuccessful attempt was made to update the actual license file and other actions may be taken in response. If the authentication and/or validation is successful at 378, the lockstep processor 320 stores the updated license file, including any chronological identifier, in the RN configured to store the actual license file 336. To confirm that the newly stored (updated) actual license file does not prevent proper MCU functioning, at 380 the lockstep processor 320 boots using the updated actual license file 336 and confirms proper MCU function. This serves to validate the updated actual license file. At 382, if the MCU does not function properly an alarm is triggered and a copy of the former actual license file 338 is stored in the RN location storing the actual license file 336 to revert back to MCU operation based on the previous actual license file. At 382, if the MCU functions properly, at 384 the lockstep processor stores a copy of the actual license file 336 in the RN location for the actual license file copy 338. At 386, a software reset is triggered to activate the new license. The marking circuitry will use the actual license file 336 for marking in subsequent boot operations.

The lockstep processor 320 may increment an update counter (not shown) upon activating the new license. The update circuitry may use the update counter to track the number of license updates that are performed and refrain from performing license updates once the update counter reaches a predetermined limit on the number of updates. The maximum number of updates that is allowed may be set at MCU manufacture or modified in-field as part of a purchased upgrade.

In this manner, once activated, the umbrella license file and the actual license file can be used during the boot cycle without requiring additional validation, cryptographic or security or safety related operations. The umbrella license file is stored in NRN and subject to native integrity detection measures associated with the NRN. The actual license file has been authenticated based on cryptographic keys and proper operation of the MCU using the actual license file has already been confirmed by the update circuitry as just outlined. The native error correction measures of the RN 330 protect the actual license file from errors. Thus, the umbrella license file 346 and the actual license file 336 may be trusted as being safe and secure. In some examples, to provide additional security, the actual license file may be validated in every boot cycle or selected boot cycles in the manner outlined above with respect to the updated license file.

It can be seen from the foregoing description that the disclosed systems, methods, and circuitries support flexible in-field re-marking with protections against license misuse.

In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, circuitries, systems, etc.), the terms (including a reference to a "means") used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

Examples can include subject matter such as a method, means for performing acts or blocks of the method, at least one machine-readable medium including instructions that, when performed by a machine cause the machine to perform operations according to embodiments and examples described herein.

### Examples

Example 1 is a micro-controller unit (MCU), including one or more processors; non-reprogrammable memory coupled to the one or more processors and configured to store an umbrella license file defining a first set of MCU functions or MCU resources that are enabled for execution or access by the one or more processors and a second set of MCU functions or MCU resources that are permanently disabled for execution or access by the one or more processors; reprogrammable memory coupled to the one or more processors and configured to store an actual license file defining a third set of MCU functions or MCU resources that are licensed for execution or access by the one or more processors; and marking circuitry configured to control access to the MCU functions and MCU resources based on the umbrella license file and the actual license file.

Example 2 includes the subject matter of example 1, including or omitting optional elements, wherein the umbrella license file and the actual license file include bit vectors having bit values that either enable or disable respective MCU functions or MCU resources; and the marking circuitry is configured to enable, for use by the one or more processors the MCU functions or MCU resources associated with a logical AND operation between the first set and the third set; and disable, for use by the one or more processors the MCU functions or MCU resources associated with the second set.

Example 3 includes the subject matter of example 1, including or omitting optional elements, wherein the marking circuitry is configured to validate the actual license file based on a version string associated with the actual license file and a version string stored by the marking circuitry.

Example 4 includes the subject matter of example 1, including or omitting optional elements, wherein each MCU function is associated with a range of memory mapped input/output addresses storing function-related data or instructions for performing the MCU function or each MCU resource comprises a processor core, a range of memory addresses, or a peripheral device.

Example 5 includes the subject matter of example 1, including or omitting optional elements, wherein the MCU functions include an emulator function and the MCU resources include an extension memory configured to store data generated by the emulator function.

Example 6 includes the subject matter of example 1, including or omitting optional elements, wherein the MCU functions include a cryptographic service and the MCU resources include memory configured to store cryptographic information.

Example 7 includes the subject matter of example 1, including or omitting optional elements, including update circuitry configured to validate an updated license file; and in response to successful validation of the updated license file, replace the actual license file with the updated license file in the reprogrammable memory.

Example 8 includes the subject matter of example 7, including or omitting optional elements, wherein the update circuitry is configured to validate the updated license file based on information associated with the umbrella license file and stored in non-reprogrammable memory.

Example 9 includes the subject matter of example 8, including or omitting optional elements, wherein the information associated with the umbrella license file includes first cryptographic information and wherein the update circuitry is configured to evaluate second cryptographic information associated with the updated license file based on the first cryptographic information.

Example 10 includes the subject matter of example 8, including or omitting optional elements, wherein the information associated with the umbrella license file includes an original serial number, an original version number, or an original date and wherein the update circuitry is configured to validate the updated license file when the updated license file includes a serial number, version number, or date that is later than the original serial number, the original version number, or the original date.

Example 11 includes the subject matter of example 8, including or omitting optional elements, wherein the update circuitry includes an update counter that is incremented with each updated license file, the update circuitry further configured to refrain from validating an updated license file when the update counter reaches a threshold value.

Example 12 is marking circuitry, including one or more processors coupled to reprogrammable memory and non-reprogrammable memory, the one or more processors configured to, when executing instructions stored in the non-reprogrammable memory, perform operations including based on an umbrella license file stored in the non-reprogrammable memory, identifying a first set including MCU functions or MCU resources that are enabled for use by the one or more processors; identifying a second set including MCU functions or MCU resources that are permanently disabled for use by the one or more processors; based on an actual license file stored in the reprogrammable memory, identifying a third set including MCU functions or MCU resources that are licensed for use by the one or more processors; and controlling access to the MCU functions or MCU resources based on the umbrella license file and the actual license file.

Example13 includes the subject matter of example 12, including or omitting optional elements, wherein the umbrella license file and the actual license file include bit vectors having bit values that either enable or disable respective MCU functions or MCU resources; and the operations include enabling, for use by the one or more processors the MCU functions or MCU resources associated with a logical AND operation between the first set and the third set; and disabling, for use by the one or more processors the MCU functions or MCU resources associated with the second set.

Example 14 includes the subject matter of example 12, including or omitting optional elements, wherein operations include validating the actual license file based on a version string associated with the actual license file and a version string stored by the marking circuitry.

Example 15 includes the subject matter of example 12, including or omitting optional elements, wherein the second set includes MCU functions or MCU resources associated with cryptographic services or cryptographic information.

Example 16 is update circuitry, including one or more processors coupled to reprogrammable memory and non-reprogrammable memory, the one or more processors configured to, when executing instructions stored in the non-reprogrammable memory, perform operations including validating an updated license file; and in response to successful validation of the updated license file, replacing an actual license file in the reprogrammable memory with the updated license file.

Example 17 includes the subject matter of example 16, including or omitting optional elements, wherein the operations include validating the updated license file based on information associated with an umbrella license file and stored in the non-reprogrammable memory.

Example 18 includes the subject matter of example 17, including or omitting optional elements, wherein the information associated with the umbrella license file includes first cryptographic information and wherein the operations include validating second cryptographic information associated with the updated license file based on the first cryptographic information.

Example 19 includes the subject matter of example 17, including or omitting optional elements, wherein the information associated with the umbrella license file includes an original serial number, an original version number, or an original date and wherein the operations include validating the updated license file when the updated license file includes a serial number, version number, or date that is later than the original serial number, the original version number, or the original date.

Example 20 includes the subject matter of example 17, including or omitting optional elements, wherein the operations include refraining from validating an updated license file when an update counter stores a threshold value.

Various illustrative logics, logical blocks, modules, circuitries, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine.

In the present disclosure like reference numerals are used to refer to like elements throughout, and wherein the illustrated structures and devices are not necessarily drawn to scale. As utilized herein, terms “module”, “component,” “system,” “circuit,” “circuitry,” “element,” “slice,” and the like are intended to refer to a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuitries can reside within a process, and circuitry can be localized on one computer and/or distributed between two or more computers. A set of elements or a set of other circuitry can be described herein, in which the term “set” can be interpreted as “one or more.”

As another example, circuitry or similar term can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include field gates, logical components, hardware encoded logic, register transfer logic, one or more processors therein to execute software and/or firmware that confer(s), at least in part, the functionality of the electronic components.

Use of the word exemplary is intended to present concepts in a concrete fashion. The terminology used herein is for the purpose of describing particular examples only and is not intended to be limiting of examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. As used herein the term “or” includes the option of all elements related by the word or. For example A or B is to be construed as include only A, only B, and both A and B. Further the phrase “one or more of” followed by A, B, or C is to be construed as including A, B, C, AB, AC, BC, and ABC.

What is claimed is:

1. A micro-controller unit (MCU), comprising:
one or more processors;
non-reprogrammable memory coupled to the one or more processors and configured to store an umbrella license file defining a first set of MCU functions or MCU resources that are enabled for execution or access by the one or more processors and a second set of MCU functions or MCU resources that are permanently disabled for execution or access by the one or more processors;
reprogrammable memory coupled to the one or more processors and configured to store an actual license file defining a third set of MCU functions or MCU resources that are licensed for execution or access by the one or more processors; and
marking circuitry configured to control access to the MCU functions and MCU resources based on the umbrella license file and the actual license file.

2. The MCU of claim 1, wherein
the umbrella license file and the actual license file comprise bit vectors having bit values that either enable or disable respective MCU functions or MCU resources; and
the marking circuitry is configured to
enable, for use by the one or more processors the MCU functions or MCU resources associated with a logical AND operation between the first set and the third set; and
disable, for use by the one or more processors the MCU functions or MCU resources associated with the second set.

3. The MCU of claim 1, wherein the marking circuitry is configured to validate the actual license file based on a version string associated with the actual license file and a version string stored by the marking circuitry.

4. The MCU of claim 1, wherein each MCU function is associated with a range of memory mapped input/output addresses storing function-related data or instructions for performing the MCU function or each MCU resource comprises a processor core, a range of memory addresses, or a peripheral device.

5. The MCU of claim 1, wherein the MCU functions include an emulator function and the MCU resources include an extension memory configured to store data generated by the emulator function.

6. The MCU of claim 1, wherein the MCU functions include a cryptographic service and the MCU resources include memory configured to store cryptographic information.

7. The MCU of claim 1, comprising update circuitry configured to
validate an updated license file; and
in response to successful validation of the updated license file, replace the actual license file with the updated license file in the reprogrammable memory.

8. The MCU of claim 7, wherein the update circuitry is configured to validate the updated license file based on information associated with the umbrella license file and stored in non-reprogrammable memory.

9. The MCU of claim 8, wherein the information associated with the umbrella license file comprises first cryptographic information and wherein the update circuitry is configured to evaluate second cryptographic information associated with the updated license file based on the first cryptographic information.

10. The MCU of claim 8, wherein the information associated with the umbrella license file comprises an original serial number, an original version number, or an original date and wherein the update circuitry is configured to validate the updated license file when the updated license file includes a serial number, version number, or date that is later than the original serial number, the original version number, or the original date.

11. The MCU of claim 8, wherein the update circuitry comprises an update counter that is incremented with each updated license file, the update circuitry further configured to refrain from validating an updated license file when the update counter reaches a threshold value.

12. Marking circuitry, comprising one or more processors coupled to reprogrammable memory and non-reprogrammable memory, the one or more processors configured to, when executing instructions stored in the non-reprogrammable memory, perform operations comprising:
based on an umbrella license file stored in the non-reprogrammable memory,
identifying a first set comprising MCU functions or MCU resources that are enabled for use by the one or more processors;
identifying a second set comprising MCU functions or MCU resources that are permanently disabled for use by the one or more processors;
based on an actual license file stored in the reprogrammable memory, identifying a third set comprising MCU functions or MCU resources that are licensed for use by the one or more processors; and
controlling access to the MCU functions or MCU resources based on the umbrella license file and the actual license file.

13. The marking circuitry of claim 12, wherein
the umbrella license file and the actual license file comprise bit vectors having bit values that either enable or disable respective MCU functions or MCU resources; and
the operations comprise
enabling, for use by the one or more processors the MCU functions or MCU resources associated with a logical AND operation between the first set and the third set; and
disabling, for use by the one or more processors the MCU functions or MCU resources associated with the second set.

14. The marking circuitry of claim 12, wherein operations comprise validating the actual license file based on a version string associated with the actual license file and a version string stored by the marking circuitry.

15. The marking circuitry of claim 12, wherein the second set comprises MCU functions or MCU resources associated with cryptographic services or cryptographic information.

16. Update circuitry, comprising one or more processors coupled to reprogrammable memory and non-reprogrammable memory, the one or more processors configured to, when executing instructions stored in the non-reprogrammable memory, perform operations comprising:
validating an updated license file; and
in response to successful validation of the updated license file, replacing an actual license file in the reprogrammable memory with the updated license file.

17. The update circuitry of claim 16, wherein the operations comprise validating the updated license file based on information associated with an umbrella license file and stored in the non-reprogrammable memory.

18. The update circuitry of claim 17, wherein the information associated with the umbrella license file comprises first cryptographic information and wherein the operations comprise validating second cryptographic information associated with the updated license file based on the first cryptographic information.

19. The update circuitry of claim 17, wherein the information associated with the umbrella license file comprises an original serial number, an original version number, or an original date and wherein the operations comprise validating the updated license file when the updated license file includes a serial number, version number, or date that is later than the original serial number, the original version number, or the original date.

20. The update circuitry of claim 17, wherein the operations comprise refraining from validating an updated license file when an update counter stores a threshold value.
